(19) United States
(12) Patent Application Publication
(10) Pub. No.: US 2008/0192117 A1
(43) Pub. Date: Aug. 14, 2008

(54) DRIVER PERSPECTIVE HELMET-MOUNTED VIDEO CAMERA

(75) Inventors: David Eric Shanks, Los Angeles, CA (US); Christopher J. Long, Los Alamitos, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 12/026,982

(22) Filed: Feb. 6, 2008

Related U.S. Application Data
(60) Provisional application No. 60/888,683, filed on Feb. 7, 2007.

(51) Int. Cl. H04N 7/18; H04N 5/445

(52) U.S. Cl. 348/157; 725/38; 348/E07.085

(57) ABSTRACT

Systems and apparatuses for displaying a participant perspective on a monitor are disclosed. A mosaic video channel in accordance with the present invention has a plurality of individual video feeds, and comprises a plurality of video cells presenting at least video information, each video cell associated with one of the plurality of individual video feeds, a cursor, which can be moved between the plurality of video cells, for selecting at least one characteristic associated with a selected video cell, and a receiver, coupled to the monitor and receiving the mosaic video channel, wherein at least one of the individual video feeds being a video feed that is taken from a perspective of a participant in an event.

### CROSS-REFERENCE TO RELATED APPLICATIONS

This application claims the benefit under 35 U.S.C Section 119(e) of U.S. Provisional Application Ser. No. 60/888,683, filed on Feb. 7, 2007, by David E. Shanks et al., entitled “DRIVER PERSPECTIVE HELMET-MOUNTED VIDEO CAMERA,” which application is incorporated by reference herein.

### BACKGROUND OF THE INVENTION

1. Field of the Invention

The present invention relates generally to satellite video systems, and in particular, to a driver perspective helmet-mounted video camera.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location and additional orbital locations without departing from the scope of the present invention.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Alternatively, uplink facilities 118 can send signals via cable 122 either in conjunction with uplink signals 116 or instead of uplink signals 116 to IRD 112, for display on monitor 114.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz, or in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention discloses systems and apparatuses for displaying a participant perspective on a monitor. A mosaic video channel in accordance with the present invention has a plurality of individual video feeds, and comprises a plurality of video cells presenting at least video information, each video cell associated with one of the plurality of individual video feeds, a cursor, which can be moved between the plurality of video cells, for selecting at least one characteristic associated with a selected video cell, and a receiver, coupled to the monitor and receiving the mosaic video channel, wherein at least one of the individual video feeds being a video feed that is taken from a perspective of a participant in an event.

Such a channel further optionally includes the participant being a driver of an automobile, the automobile being a race car, the perspective of the participant being substantially replicated by the video feed, the at least one of the individual video feeds being shot from a headpiece of the participant, and the headpiece being a helmet.

A system for presenting a participant perspective of an event in accordance with the present invention, comprises a camera, coupled to at least one participant, a transmitter, coupled to the camera, for transmitting a video signal from the camera, a receiver, receiving the transmitted video signals, and a monitor, coupled to the receiver, for displaying the video signals from the camera.

Such a system further optionally includes the monitor further displays a second video signals from a second camera, the video signal and the second video signal being taken from different perspectives, the video signal and the second video signal providing simultaneous perspectives of the event, and the camera being located remotely from the participant.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

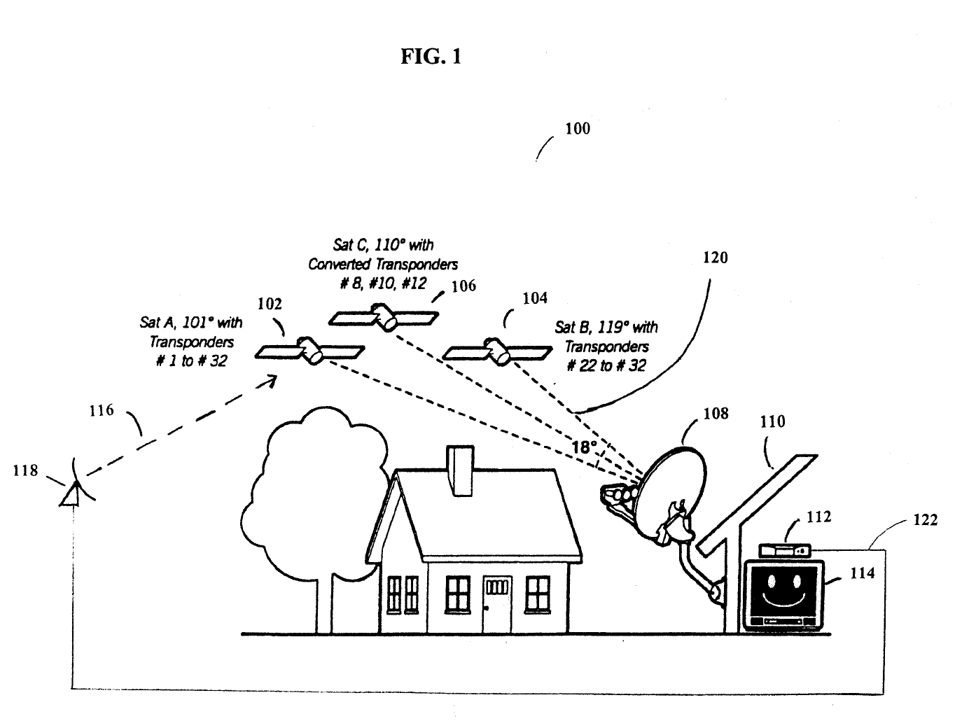

FIG. 2A illustrates a typical six-cell matrix with a generic video feed in accordance with the present invention;

FIG. 2B illustrates a remote control used in the present invention; and

FIG. 3 illustrates an embodiment showing various video cell inputs in accordance with the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Interactive Mosaic Channel Display Diagram

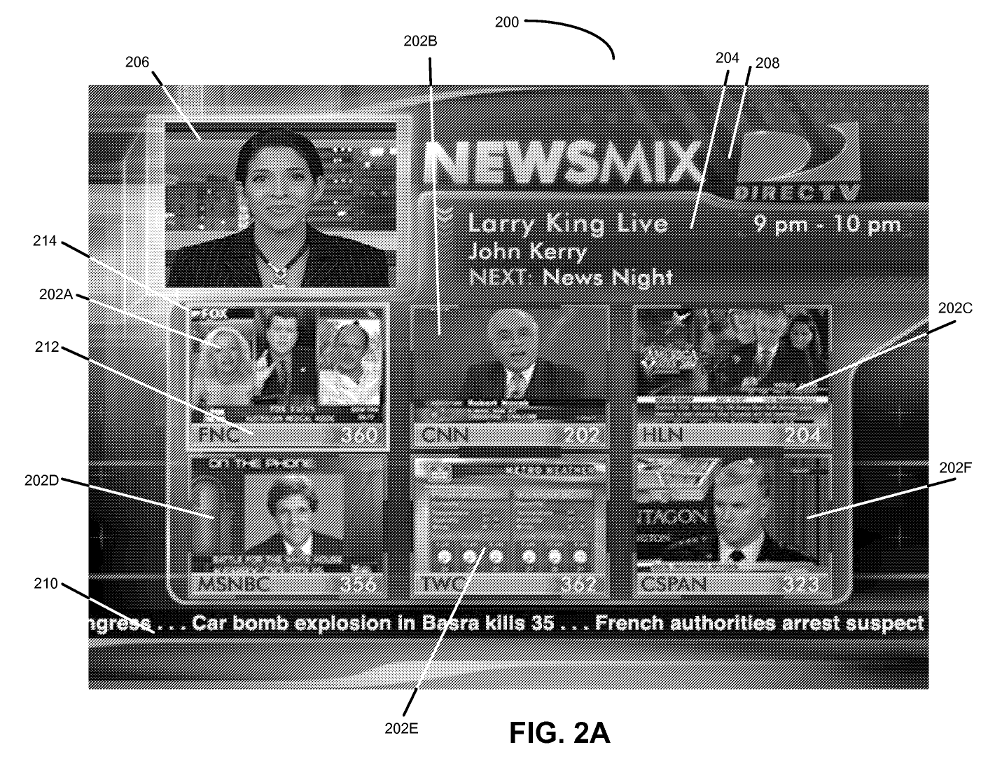

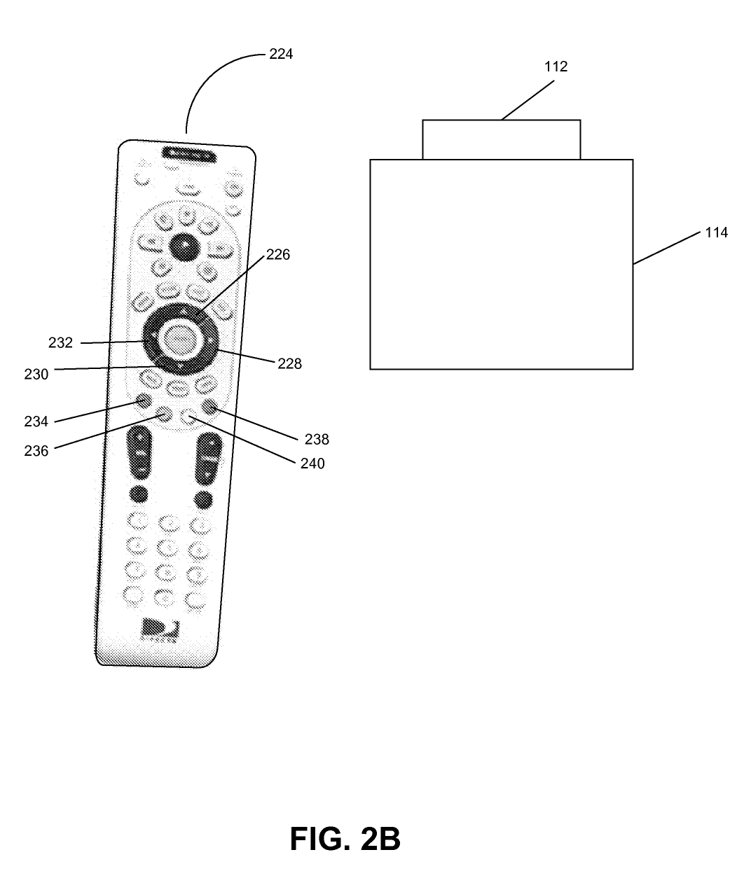

FIG. 2A illustrates a typical matrix with a generic video feed in accordance with the present invention.

Interactive mosaic channel 200 is shown as being displayed on monitor 114. Within interactive mosaic channel 200, there are a number of video cells 202A-202F and a text box 204, also referred to as an On Screen Display (OSD) 204. Optionally, the interactive mosaic channel 200 further comprises a separate video cell 206, also called a “barker cell” 206, a background video 208, and a control bar 210. The video cells 202A-F optionally comprise a channel identification (channel ID) portion 212. Further, cursor 214 is also optionally included to allow for interaction with each of the video cells 202A-202F and barker cell 206.

The number of video cells 202A-F can change based on the number of video cells 202 A-F desired. As the number of video cells 202A-F increases, of course, there must be a reduction in the size of the video cells 202A-F to ensure that the video cells are differentiated on the monitor 114. As the number of video cells 202A-F decreases, the size of the video cells 202A-F can increase, since there is more space available on monitor 114 to display video cells 202A-F.

Further, the placement of video cells 202A-F, barker cell 206, text box 204, and control bar 210 is not limited to the positions on monitor 114 as shown in FIG. 2A. These elements can be displayed anywhere on monitor 114 without departing from the scope of the present invention.

As there are multiple video feeds and video cell 202A-F and barker cell 206 being presented, each video cell 202A-F and barker cell 206, as well as background video 208 and possibly control bar 210, have associated audio portions that can be played. Presenting more than one audio stream may be confusing; as such, it is typical that only one audio stream of information is presented at a given time. However, each of the video feeds may also have closed-captioning information associated with it, and selection of a closed-captioned presentation, rather than an audio presentation, can be performed as described herein.

Video Cells

Video cells 202A-F each comprise a separate viewer channel of programming. So for example, in an interactive mosaic channel that is focused on news programming, cell 1 could contain the video programming associated with the viewer channel of FOX News Channel, cell 2 could contain the video programming associated with the viewer channel of CNN, cell 3 could contain the video programming associated with the viewer channel of Headline News, cell 4 could contain the video programming associated with the viewer channel of MSNBC, cell 5 could contain the video programming associated with the viewer channel of The Weather Channel, and cell 6 could contain the video programming associated with the viewer channel of C-SPAN. The placement and video programming content for each video cell 202A-F can depend on a wide variety of factors, such as Nielsen ratings for a given channel, whether a given channel is available on a specific viewer's programming package, viewer channel number (lowest to highest or highest to lowest) or can be decided or changed based on programming that is present on one or more of the viewer channels available for the interactive mosaic channel. For example, and not by way of limitation, an important vote on the floor of the Senate may be taking place, and a decision can be made to change the placement of C-SPAN from video cell 202F to video cell 202A for a period of time. Changes in presentation for the interactive mosaic channel 200 are discussed below.

Within each of the video cells 202A-F is a channel identification (ID) box 212. Typically, the channel ID box 212 indicates to the viewer the moniker or name that is associated with the video feed being shown in that respective video cell 202A-F, and the viewer channel number associated with the video feed being shown in that respective video cell 202A-F. For example and not by way of limitation, in video cell 202A, which as described above, is showing the video feed for ESPN, channel ID box 212 would indicate “ESPN” as well as, optionally, a channel number, e.g., “206” to indicate to the viewer that the video feed being shown in video cell 202A is that of ESPN, and that the viewer is accustomed to seeing this full-monitor 114 video programming on viewer channel 206.

Other information may also appear in channel ID box 212, such as an indication that the video feed that is being presented in the associated video cell 202A-F is a “user favorite” channel, the channel ID box 212 may be presented in a different color or video texture to indicate that the video feed that is being presented in the associated video cell 202A-F is a channel that presents programming that adults may wish to block from their children's view or has closed-captioning available, etc. Many possibilities are available within the scope of the present invention to present various types of video information within channel ID box 212 for viewer selection and benefit. The channel ID box 212 may also appear without a video cell 202A-F for those video feeds that are channel blocked via parental control, or otherwise unavailable to a specific viewer because of the viewer's programming package or other reasons.

Text Box

Text box 204 contains textual information that is useful to the viewer, and this information can change depending on the viewer's selection of interactive services as described herein. For example, the text box 204 can contain a generic statement about the genre of the interactive mosaic channel 200, or statements directed to a selected video cell 202A-F or information related to the channel ID box 212 to describe to a user the meaning of the information presented in the channel ID box 212 or other information related to the video cell 202A-F and channel ID box 212. The text box can also scroll to present additional information to the viewer that does not all fit within text box 204 at a given time.

There can also be default text associated with each interactive mosaic channel 200, and, depending on the capabilities of IRD 112, each time an interactive mosaic channel 200 is tuned to, a default descriptive text shall be displayed in the text box 204.

Barker Cell

Barker cell 206 is a presentation of video data that can relate to the video cells 202A-F that are present in interactive mosaic channel 200. For those interactive mosaic channels 200 that have the optional barker cell 206, the barker cell 206 can use audio or video clues to direct the user to one of the video cells 202A-F for more information on a given topic, or provide an overview of the information presented within the video cells 202A-F. For example, the audio and video associated with barker cell 206 in a news format can be a series of stories that are being covered in more depth on the viewer channels being shown in video cells 202A-F, and the barker cell 206 audio and video can then direct the viewer to tune the IRD 112 or monitor 114 to a specific video cell 202A-F for more information on that topic. The barker cell 206 can also be used to provide an overview of the news stories, either those presented in video cells 202A-F or other news stories of interest, without directing the viewer to one of the video presentations being discussed in the video feeds shown in video cells 202A-F.

Barker cell 206 can present audio and video information that is not available on any other viewer channel that is accessible to IRD 112 or monitor 114, other than within the barker cell 206 of the interactive mosaic channel 200. When the barker cell 206 presents audio and video information that is not present on any other viewer channel accessible to IRD 112 or monitor 114, then the barker cell 206 does not have an associated channel ID box 212.

Background Video

Background video 208 is typically a backdrop for the interactive mosaic channel 200. The background video 208 can be related to the genre of the interactive mosaic channel 200; for example, in a news environment, the background video 208 can be related to a top news story, the stock market exchange building, a prominent government building, etc. The background video 208 can be changed or can be a dynamic video depending on the desires of the editorial staff or viewer preferences. Further, the background video 208 can be a logo or other indicator of the source of the interactive mosaic channel 200, such as DIRECTV.

### Interactive Features

FIG. 2B illustrates a remote control used in the present invention.

Typically, IRD 112 and monitor 114 are controlled by a remote control device 224, which allows viewers a convenient way to control audio volume, channel selection, and other features and display characteristics from a distance away from the IRD 112 and/or monitor 114.

Each video cell 202A-F has an associated channel ID box 212, and one of the video cells, cell 202D, has a cursor 214 surrounding that specific video cell 202 and, optionally, channel ID box 212. The cursor 214 indicates that the specific video cell 202 and channel ID 212 has been selected by the viewer. The cursor 214 is typically controlled by buttons 226-232, but can be controlled by other buttons on the remote control 224 if desired.

By selecting a given video cell 202A-F, the viewer is selecting a specific characteristic associated with that given video cell 202A-F, or associated video feed used to generate that video cell 202A-F. In most instances, when the viewer selects a given video cell 202, the audio portion associated with the selected video cell 202 will be presented to the viewer, rather than the audio portion associated with the barker cell 206 or a generic audio track that is associated with interactive mosaic channel 200. Further, selection of a given video cell 202A-F with cursor 214 may also select a closed captioning data stream associated with the selected video cell 202, depending on the availability of such a data stream and/or other settings that a viewer has selected. Cursor 214 can be moved to any of the video cells 202A-F, and, optionally, can be moved to select text box 204 or control bar 210.

When cursor 214 is moved to a given video cell 202A-F via buttons 226-232, text box 204 also may undergo a change in information. Typically, when the video cell 202A-F is selected by the viewer, indicated by the presence of cursor 214, text box 204 will present the information in the Advanced Program Guide (APG) that is associated with the viewer channel selected by cursor 214. The APG typically includes information on the program or “show” that is currently being presented by the viewer channel shown in video cell 202A-F, as well as the time that show is being aired and the next show to be aired on that viewer channel. Other information, either in the APG or external to the APG, can also be displayed in the text box 204 when the cursor is moved to a given video cell 202A-F.

As such, the viewer can “interact” with the interactive mosaic channel 200 and decide which audio track to listen to, find out a plot line of each of the shows being presented in the various video cells 202, find out what is going to be aired next in the various viewer channels being presented in video cells 202, or listen to generic audio from the barker cell 206 or associated with the interactive mosaic channel 200 itself while variously viewing the video presentations in the video cells 202. If a specific video cell 202 presents video information that is of interest to a viewer, then the viewer can move cursor 214, via a remote control command, to a given video cell 202, and listen to the audio associated with that video cell 202 and find out more about that viewer channel in text box 204.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control 224 (typically the “select” button on a DIRECTV remote control). This will tune the IRD 112 or monitor 114 to that viewer channel, which will then be presented full-screen to the viewer as in a normal television monitor 114 viewing format.

The barker cell 206, since it typically contains audio and video information that is not located on any viewer channel other than the interactive mosaic channel 200, cannot typically be selected for full screen viewing by the viewer on monitor 114. However, the barker cell 206 can be selected for full monitor 114 viewing, or at least enough of the monitor 114 to allow for changes in the video cells 202 as described below, to allow for changes in the interactive mosaic channel 200 and in the control bar 210 in near-real-time.

### Control Bar

The Control Bar 210 (also called the Attract Icon or the Attract Icon Bar) The control bar 210 allows for instant, on-screen access to several data sources that allow the viewer to access data related to that being shown in the video cells 202A-F as well as other viewer channels available within system 100. Those IRDs 112 that have interactive capabilities have special buttons that correspond to the icons that appear on the control bar 210. Each icon/button directs the viewer to a different screen, such as special events, or, in the case of the present invention, data related to real-time or near-real-time viewership of channels within system 100. Each screen can have sub-screens that further allow related data to be viewed or otherwise analyzed by the viewer. Further, control bar 210 can comprise statistics, data, or other information related to the video cells 202A-F being shown in monitor 114.

For example, and not by way of limitation, one of the remote control 224 buttons, e.g., the “red” button 234, indicated by text and/or graphics on control bar 210, may take a viewer to the “What's Hot” page, where viewers can review data related to viewership of shows currently being aired within system 100.

Similarly, a “special” page can be accessed by pressing a different button on the remote control 224, e.g., the “green” button 236, or the blue button 238 or yellow button 240, where viewers can view a channel or other data page. The special page can be reprogrammed by the system provider or the viewer based on time, or, in the case of interactive mosaic channel 200, can be done by genre. For example, and not by way of limitation, the special page can be assigned to the NCAA bracket for a “Sports” mosaic channel 200, and, if the viewer changes to a “News” mosaic channel 200, the special page can be a breaking news channel or news recap video loop that is provided by the system provider. There can be more than one special “page” that is accessible from the buttons 234-240, or other buttons on the remote control 224, if desired.

### Video Cell Inputs

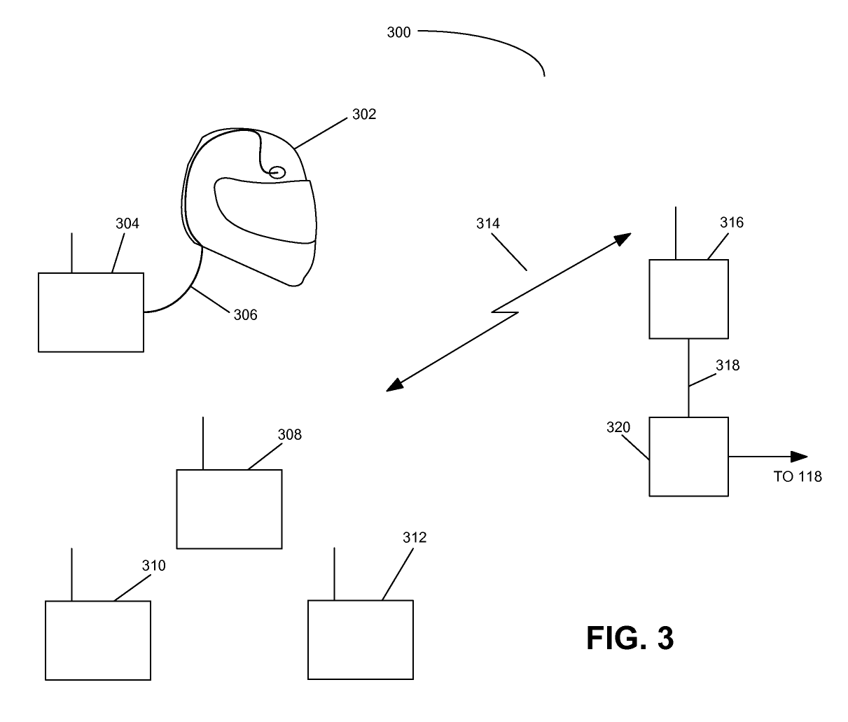

FIG. 3 illustrates an embodiment showing various video cell inputs in accordance with the present invention.

System 300 shows helmet 302 with camera 304 attached via cable 306. Additional cameras 308-312 are also present to show various other perspective views. Each of the cameras 304-312 send signals 314 to one or more transceivers 316 that output signal 318 to a production facility 320 for viewing and selective transmission of the signals 314 to uplink facility 118. Signals 114 can be sent back to cameras 304-312 as well, to control focus, sensitivity, color balance, zoom, etc., as required.

Helmet 306, when worn by a race car driver, football player, or other contestant in a sporting event, allows for the perspective of the participant to be distributed to camera 304 and transmitted via signal 314 to transceiver 316. Helmet 306 can be other headpieces, e.g., a baseball cap, or can be some other article of clothing or apparel that is worn by a participant, without departing from the scope of the present invention.

This participant perspective is unique in that the sights and, if desired, sounds that are recorded by camera 304, can be used either as entertainment for viewers of monitor 114, as a training tool for apprentices or younger players, or as a feedback tool for the person wearing helmet 306. For example, and not by way of limitation, the pictures and sounds recorded by camera 304 can be compared to those recorded by cameras 308-312, so that a composite video of a given event can be generated. The perspective of, for example, a race car driver can be recorded by camera 304, the perspective of the crew chief can be recorded by camera 308, the perspective of the pit crew can be recorded by camera 310, and the perspective of a passenger in the race car can be recorded by camera 312. The outputs of all of the cameras 304-312 can be shown on a single monitor 114, or multiple monitors 114, such that a viewer can see an event, a single point or sequence in time, from several perspectives all at once.

Such a perspective, e.g., of a central star or figure in a given event or contest, is of primary importance to viewers. Viewers like to identify with favorite players, car drivers, actors or actresses, and would like to know what the scene or event looks like from their perspective, e.g., having the camera 304 substantially replicate or approximate the viewpoint of the participant, while at the same time seeing other perspectives that are viewing the same event.

The present invention allows a viewer to participate “interactively” as an active participant in any program where the participant mounted camera of the present invention is used. So, for example, an active participant, or a “third man” that is inserted into the contest or scene solely to provide a viewer perspective, can be inserted into the scene, contest, etc., and give viewers the interactive experience of someone that is involved with the scene at hand. Such a perspective allows people to be the player or participant in the scene and also provides an omniscient viewpoint to the viewer, which is typically not available to other participants. Viewers may also be able to provide a viewer response that now allows the viewer to be involved in the scene firsthand, rather than as a passive participant in viewing a video feed. Such interaction is possible through remote control 224 that controls IRD 112.

Additional information can be sent along with the participant viewpoint video feed, e.g., heart rate, body temperature, external temperature, etc., that will allow a viewer to “feel” more in tune with the scene being presented on the video feed. So, for example, the viewer now sees, hears, or feels the physiological response of a participant, which gives the viewer a more personal, involved experience with the video being shown. Such telemetry can not only be used to further involve the viewer, but can be used to determine the motives and/or voracity of other participants where the other participants' physiological responses are also available to the viewer.

Further, the sounds that a primary participant hears and/or generates would be recorded by camera 304, which may be different than the sounds recorded by cameras 308-312. These sounds can be played back to viewers that select that particular video cell 202A-F which displays the video from camera 304.

For example, and not by way of limitation, camera 304 may be connected to helmet 306 that is being worn by a NASCAR driver. Cable 306 can be a fiber optic cable and a microphone cable that allows camera 304 to be remotely located elsewhere in the driver's car, to avoid having additional weight and/or materials that may provide discomfort to the driver or be a safety concern for the driver. As the driver looks out the windshield of his car, the camera 304 will record that view, as well as any view that the driver has of the dashboard of the car. As the driver downshifts, goes through turns on the racetrack, or sees other cars ahead, any viewer that is watching the video signal 314 coming from camera 304 sees exactly what the driver sees; camera 304 has the same perspective that the driver does.

Similarly, a camera 304 can be connected to a quarterback in a football game, and another camera 308 can be connected to a receiver. The cameras 304 and 308 can be located in the helmet 306, or in other padding that is typically worn by a football player, such that the cameras 304 and 308 do not interfere with the safety or comfort of the players. When the quarterback drops back to pass, and throws a pass to the receiver, the perspective of the quarterback is very different from the receiver; cameras 304 and 308 will record very different perspectives. It is of interest to viewers, as well as to the quarterback and receiver, and, likely, to the coaches of the team, to see what the individual players “see” during such a play. If the receiver drops the pass, it would be of interest to the coaches, from the perspective of the receiver, to see why the pass was dropped; if the ball arrived too late for the receiver to notice it, if the ball was delivered too high or too low, etc. This provides feedback to the receiver and to the quarterback to change something, whether it is for the receiver to look back for the ball earlier, or for the quarterback to deliver the ball in a different area, to allow for a reception on subsequent plays. Further, the present invention can be used at any filming location where a participant perspective is desirable.

### CONCLUSION

The present invention discloses systems and apparatuses for displaying a participant perspective on a monitor. A mosaic video channel in accordance with the present invention has a plurality of individual video feeds, and comprises a plurality of video cells presenting at least video information, each video cell associated with one of the plurality of individual video feeds, a cursor, which can be moved between the plurality of video cells, for selecting at least one characteristic associated with a selected video cell, and a receiver, coupled to the monitor and receiving the mosaic video channel, wherein at least one of the individual video feeds being a video feed that is taken from a perspective of a participant in an event.

Such a channel further optionally includes the participant being a driver of an automobile, the automobile being a race car, the perspective of the participant being substantially replicated by the video feed, the at least one of the individual video feeds being shot from a headpiece of the participant, and the headpiece being a helmet.

A system for presenting a participant perspective of an event in accordance with the present invention, comprises a camera, coupled to at least one participant, a transmitter, coupled to the camera, for transmitting a video signal from the camera, a receiver, receiving the transmitted video signals, and a monitor, coupled to the receiver, for displaying the video signals from the camera.

Such a system further optionally includes the monitor further displays a second video signals from a second camera, the video signal and the second video signal being taken from different perspectives, the video signal and the second video signal providing simultaneous perspectives of the event, and the camera being located remotely from the participant.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims appended hereto and by the full range of equivalents to the claims appended hereto.

What is claimed is:

1. A mosaic video channel displayed on a monitor, with a plurality of individual video feeds being presented at a given time, comprising
a plurality of video cells presenting at least video information, each video cell associated with one of the plurality of individual video feeds;
a cursor, which can be moved between the plurality of video cells, for selecting at least one characteristic associated with a selected video cell; and
a receiver, coupled to the monitor and receiving the mosaic video channel, wherein at least one of the individual video feeds being a video feed that is taken from a perspective of a participant in an event.

2. The mosaic video channel of claim 1, wherein the participant is a driver of an automobile.

3. The mosaic video channel of claim 2, wherein the automobile is a race car.

4. The mosaic video channel of claim 1, wherein the perspective of the participant is substantially replicated by the video feed.

5. The mosaic video channel of claim 1, wherein the at least one of the individual video feeds is shot from a headpiece of the participant.

6. The mosaic video channel of claim 6, wherein the headpiece is a helmet.

7. A system for presenting a participant perspective of an event, comprising:
a camera, coupled to at least one participant;
a transmitter, coupled to the camera, for transmitting a video signal from the camera;
a receiver, receiving the transmitted video signals; and
a monitor, coupled to the receiver, for displaying the video signals from the camera.

8. The system of claim 7, wherein the monitor further displays a second video signals from a second camera, the video signal and the second video signal being taken from different perspectives.

9. The system of claim 8, wherein the video signal and the second video signal provide simultaneous perspectives of the event.

10. The system of claim 7, wherein the camera is located remotely from the participant.
